(19) United States
(12) Patent Application Publication
(10) Pub. No.: US 2007/0080013 A1
(43) Pub. Date: Apr. 12, 2007

(54) Device and method for protecting passengers in a vehicle

(76) Inventors: Tobias Melz, Darmstadt (DE); Michael Matthias, Darmstadt (DE); Eric Zimmerman, Kassel (DE); Rudolf Aufmolk, Gross Genau (DE); Harald Kollner, Altenstadt (DE)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/571,111

(22) PCT Filed: Aug. 31, 2004
(86) PCT No.: PCT/EP04/09694

§ 371 Date: Dec. 11, 2006

(30) Foreign Application Priority Data
Sep. 8, 2003 (DE) 103 41 328.6

(51) Int. Cl. B60K 28/10; B60N 2/02; B60N 2/42

(52) U.S. Cl. 180/274; 296/68.1; 297/216.19

(57) ABSTRACT

A device and a method are described for improving the protection of passengers in a vehicle, particularly in a motor vehicle, by reducing a force input, which is caused during a collision of the vehicle, physiologically acting on a passengers seated on a vehicle seat, using a vehicle seat positioned movably in relation to the vehicle, which may be displaced from a rest position in movement in relation to the vehicle by at least one activatable actuator, as well as an analysis and control unit, which activates the actuator for targeted vehicle seat movement as a function of sensor signals, which originate from sensors attached to the vehicle, and of predefinable reference values. The present invention is distinguished in that the at least one activatable actuator has an intelligent structure, which undergoes a shape change initiating the vehicle seat movement through activation on the basis of at least one conversion material.

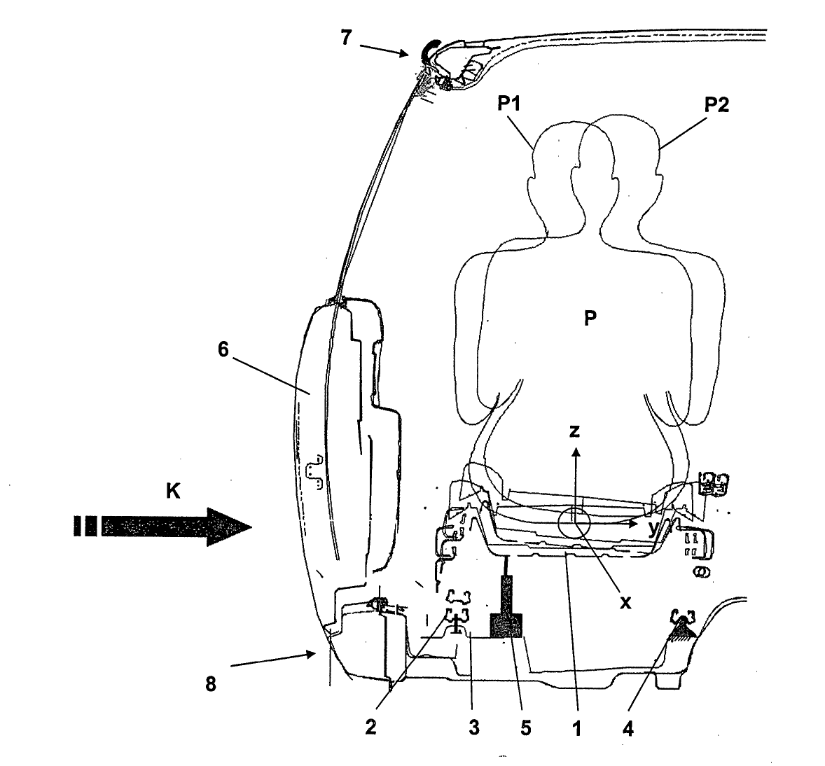

### TECHNICAL AREA

The present invention relates to a device and a method for protecting passengers in a vehicle, particularly in a motor vehicle, by reducing a force input, which is caused during a collision of the vehicle, physiologically acting on a passengers seated on a vehicle seat, using a vehicle seat positioned movably in relation to the vehicle, which may be set into motion in relation to the vehicle from a rest position by at least one activatable actuator, as well as an analysis and control unit, which activates the actuator for targeted vehicle seat movement as a function of sensor signals, which originate from sensors attached to the vehicle, and of predefinable reference values.

### PRIOR ART

A device for protecting passengers in a vehicle of the above-mentioned species, through which the active force input physiologically acting on a passenger of the vehicle during a vehicle collision is to be reduced, is disclosed in DE 23 44 689, in which, in case of a collision, the vehicle seat is moved against the travel direction and/or in the travel direction using an actuating device, the seat delay rising rapidly in the scope of the human compatibility range and then being held at an essentially constant level within this scope. The actuating device required for this purpose is formed by a pressure-controlled cylinder, which is first activated after the collision event with the aid of conventional sensor technology.

An improvement of the passenger protection device described above is disclosed in EP 0 691 910 B1, which also provides a vehicle seat movable in relation to the vehicle body, in which, however, a seat deflection in relation to the vehicle body already occurs at an instant in which an imminent collision is recognized as unavoidable. A timely early recognition of a collision situation occurs with the aid of a suitable proximity sensor system attached to the vehicle, which activates actuators attached to the motor vehicle seat appropriately upon detection of a chronologically imminent collision event, which operate using hydraulic, pneumatic, mechanical, pyrotechnic, or electrical operating mechanisms. All actuators known up to this point are constructed at different levels of complexity as a function of the particular functional principle, as listed in sequence above, and require maintenance to be performed separately, if it is to be ensured that the actuators function perfectly in case of collision. The actuators known and used up to this point also do not allow any or only a very limited possibility for setting the actuator function as a function of the particular case of the collision and of the size and weight of the person seated on a vehicle seat.

In addition, the seat adjustments in relation to the vehicle body known up to this point are restricted to the directions in or against the travel direction, so that the passenger protection may only be improved to a very limited extent using the systems known until now, particularly in the event of collision torques acting on the vehicle diagonally to the travel direction or even in the event of side impact collisions.

A tilting device for a motor vehicle seat, which is mounted so it is tiltable around a lateral edge running in the travel direction, is described in DE 195 30 219. It may be seen from the various figures which accompany the publication that the motor vehicle seat may be transferred into a tilted position from a rest position with the aid of suitable spring systems. The spring systems may comprise rubber or rubber-like plastics.

A safety device for protecting a vehicle passenger in the event of a side impact, according to which the motor vehicle seat is mounted so it is rotatable around its particular vertical axis, is disclosed in DE 42 09 605 A1. In case of a side impact, the seat is pivoted in such a way that an area of the back rest of the particular seat is pivoted between the vehicle passenger and the side wall of the vehicle impinged by the crash. Electric motor or pyrotechnic drives, through which the seat is pivoted out of its rest position, are used for pivoting.

### DESCRIPTION OF THE INVENTION

The present invention is based on the object of refining a device and a method for protecting passengers in a vehicle, particularly in a motor vehicle, by reducing a force input, which is caused during a collision of the vehicle, physiologically acting on a passenger seated on a vehicle seat, using a vehicle seat positioned movably in relation to the vehicle, which may be set in motion in relation to the vehicle from a rest position by at least one activatable actuator, as well as an analysis and control unit, which activates the actuator for targeted vehicle seat movement as a function of sensor signals, which originate from sensors attached to the vehicle, and of predefinable reference values, in such a way that the passenger protection is improved in cases of collision, in particular, the force torques acting on the particular passengers are to be reduced to a physiologically acceptable level, in order to finally decisively reduce the danger of injury to passengers. The technical features to be met are to be able to be implemented using the simplest possible means, which do not require any maintenance outlay and nonetheless are to operate reliably.

The achievement of the object on which the present invention is based is specified in claims 1 and 2. The subject matter of claim 12 is a method according to the present invention. Features which advantageously refine the idea of the present invention are the subject matter of the subclaims and may be inferred from the description with reference to the exemplary embodiments.

According to the present invention, a device according to the preamble of claim 1 is implemented in such a way that the at least one activatable actuator has an intelligent structure, which experiences a shape change initiating the vehicle seat movement through activation on the basis of at least one conversion material.

Conversion materials are materials known per se, which are used in particular in the fields of mechatronics and adaptronics and, through supply and/or control of energy and activation and/or control of material properties, allow a coupled, well controllable change of structural-mechanical properties such as damping, rigidity, and geometry. Materials of this type are of interest in particular in cases in which the materials are used for impact or oscillation absorption.

Different forms of energy are available for controlling conversion materials depending on the type of material, such as electrical, magnetic, and/or thermal energy. For the intended purpose according to the present invention, solid conversion materials are especially advantageously suitable, such as piezo ceramics, electrostrictive ceramics, magnetostrictive alloys, but above all shape memory alloys and/or shape memory metals. The latter undergo a spontaneous shape change through targeted application of an electrical voltage. The electrical voltage causes a current flow within the material, which results in spontaneous heating of the material and a structural change connected thereto in the course of the resistance heat loss. Known representatives of this conversion material group are, for example, nickel-titanium alloys, which are capable of achieving a spontaneous volume expansion of up to 8% in the event of corresponding application of electrical current. This property particularly causes this material to take the centerpoint of further application for integration in an actuator, in the sense of an intelligent structure, for targeted vehicle seat movement and/or displacement.

In principle, however, actuators which allow the integration of liquid or viscous conversion materials may also be implemented, for example, through corresponding encapsulation of piezo polymers, electrorheological or magnetorheological fluids, as well as polymer gels and shape memory polymers. These types of materials, which appear more complicated than solid conversion materials for purposes of integration into an actuator, may not appear as outstandingly relevant in the further embodiments, but their use is also to be included in the idea on which the present invention is based. The use of conventional actuators for moving the seat in the way described is also conceivable in principle.

The targeted use of intelligent structures in at least one actuator which changes the vehicle seat position within a motor vehicle opens up the possibility of not only changing the vehicle seat in its position in relation to the motor vehicle at a negligible response speed, but rather, in addition, conversion materials offer a controllable, variable, and individually regulated possibility for adjusting the material rigidity and damping, through which the dynamic properties of the seat may be controlled in a targeted way. In contrast to conventional actuators, which require interaction of multiple components for the purpose of spatial deflection, for example, as noted in the beginning, such as lifting piston systems, the deflection mechanism with conversion materials is based on intrinsic material changes, which have almost no wear effects and are therefore maintenance-free.

A preferred embodiment of the vehicle seat therefore provides at least one actuator implemented as an intelligent structure between the floor area of the vehicle body and the vehicle seat, which is operationally linked to the vehicle seat at least shortly before but above all during a collision, in order to deflect this seat in a targeted way.

To avoid a direct permanent load and possible aging of the actuator, e.g., through the inertia of the vehicle seat and a person located thereon, the vehicle seat is preferably supported via actively removable, lockable support points on the floor area of the vehicle body, which may be unlocked before or during a collision, so that the vehicle seat is movable and/or pivotable in a specific direction using the actuator.

Of course, multiple actuators may be provided for the targeted vehicle seat movement, which are preferably placed between the floor area of the vehicle body and the vehicle seat at suitable points, so that the vehicle seat is movable not only in the plane of the vehicle floor, but rather, particularly also through tilting of the vehicle seat, is also tiltable around an axis running in the travel direction and also transversely thereto.

Thus, in addition to the targeted use of actuators based on conversion materials for vehicle seat movement in case of collision, it has additionally been recognized according to the present invention that the energy input acting on a passenger in case of collision results in a significant reduction of the damage caused by collision to the passenger through targeted rotation of the vehicle seat before and during the collision.

An embodiment of a vehicle seat according to the present invention, whose mobility is describable by at least two spatial axes, namely a x axis directed in the vehicle longitudinal direction and a y axis oriented perpendicularly to the x axis, which is also oriented perpendicularly to a vertical axis passing through the vehicle seat, the z axis, provides at least one actuator between the floor area of the vehicle body and the vehicle seat in such a way that the vehicle seat is pivotable around the x axis. Furthermore, at least one further actuator is preferably provided in such a way that the vehicle seat is pivotable around a y axis. The embodiment is also provided in such way that a rotation around the z axis is possible.

It has thus been shown to be especially advantageous in cases of collision, in which a lateral energy input acts on the vehicle (side impact constellation), for reasons of reducing the physiological passenger strain, if the vehicle seat undergoes a rotation around the x axis, comparable to a roll movement, before and in the moment of the side impact, so that the angle between the crash energy flow originating from the side impact and the spinal column extension of the particular passenger is greater or less than 90° and is not predominantly 90° as in the normal case without seat rotation. In contrast, if there is a frontal impact, a rotation of the vehicle seat around the y axis favors a reduction of the physiological passenger strain through a controlled pitch movement in such way that the torso and head area of the particular passenger is pivoted against or in the travel direction together with the vehicle seat.

Achievements of the object which cause pivoting and/or tilting of the vehicle seat both around the x axis and also around the y axis are also conceivable, particularly if multiple actuators engaging on the vehicle seat are used. Combined pivoting of the vehicle seat of this type may be implemented using at least three, preferably four actuators, for example, which are connected to the vehicle body floor below the vehicle seat. Arbitrary vehicle seat inclinations may be performed depending on the activation of the particular actuators, which are activatable separately from one another.

A targeted seat rotation around the vertical axis, the z axis, is also imaginable as technically achievable, in that the vehicle seat is mounted on a rotation point attached centrally below the vehicle seat. An unlockable lock is to be provided for secure, solid mounting of the vehicle seat, which is only to be opened in case of collision and ensures a rotation of the vehicle seat around the vertical axis supported by the actuator.

The actuators for tilting the vehicle seat are not necessarily to be implemented as intelligent structures. In principle, it is possible to implement the actuators as conventional final control elements, for example, as pneumatic or hydraulic piston lifting units or in the form of drives driven by electrical or magnetic motors, the use of pyrotechnic actuators also being conceivable. However, the implementation of the actuators in the way described at the beginning is especially advantageous, namely through targeted use of conversion materials, which are capable of controlled shape change.

As already noted, a secure and solid mounting of the vehicle seat is required, which is guaranteed by appropriate actively removable, lockable support points, which solidly connect the vehicle seat to the floor area of the vehicle body. The connections are only to be opened without delay in or shortly before the collision, so that the actuators may move the vehicle seat in a suitable way, as defined by the linear and/or rotational movements described above. The locking mechanisms themselves are advantageously also implemented with the aid of conversion materials, preferably using shape memory alloys, which are activatable chronologically immediately before occurrence of a collision and during the collision and transfer an appropriately implemented locking mechanism into an open position.

In addition to the function described above of the particular actuators for targeted movement and/or tilting of the vehicle seat, the conversion materials, because of their individually adjustable material characteristics in relation to their material rigidity, are also used as variably adjustable damping elements, which allow shock pulse absorption, through which the shock strain on the passengers is reduced.

An analysis and control unit provided in the motor vehicle is used for activating the actuators operationally linked to the particular vehicle seat, which analyzes sensor signals from suitable sensor units attached to the motor vehicle to judge possibly approaching collision situations and, in case of a chronologically imminent collision situation which has been recognized is unavoidable, outputs appropriate signals to the particular actuators. Corresponding proximity sensors are provided on the vehicle for detecting the particular collision situations, using which an object approach is detectable. In addition, acceleration sensors attached to the motor vehicle contribute to determining the occurrence of a collision without doubt in this case, through which the airbag system in the vehicle interior is triggered, for example.

The individual actuators are activated as a function of the detected collision situation on the basis of the activation technologies known from adaptronics and mechatronics. Reference is expressly made at this point to the two above-mentioned technical fields, in which conversion materials play a central role.

### BRIEF DESCRIPTION OF THE INVENTION

The present invention will be described on the basis of an exemplary embodiment with reference to the single figure, which represents a schematic cross-section through a passenger cell of a motor vehicle.

A person P is seated on the driver seat 1 of a motor vehicle. The person P, shown strongly schematically, is shown in two situations, namely in a base status P1 and in a collision status P2. The vehicle seat 1, which is also shown in the two states identified above, is connected to the vehicle floor 3 in the base state using a removably fixed fixing mechanism 2. On the other side, the vehicle seat 1 is engaged non-removably, but rotationally movable with a spherical head element 4 solidly attached to the floor area 3. Furthermore, an actuator 5 is provided below the vehicle seat 1, which is also supported on the vehicle floor 3. A vehicle door 6 is indicated in cross-section left of the vehicle seat 1, which presses against the roof area 7 and the threshold area 8 of the motor vehicle. Sensor systems, through which a chronologically immediately imminent collision danger and/or the occurrence of a collision is detected and relayed in the form of sensor signals to an analysis and control unit, which finally causes the functions described below, are not shown in the figure.

In the case shown, it is assumed that a lateral force input K acts on the motor vehicle, as occurs in a side impact situation, for example. In this situation, the fixing mechanism 2 is loosened, which, like the actuator 5, has a conversion material, which releases the fixing mechanism 3 through appropriate electrical activation. Immediately following this, the converter element provided in the actuator 5, preferably in the form of a shape memory alloy, undergoes a spontaneous length extension, through which the vehicle seat 1 is raised on one side according to the situation shown in the figure. In this case, a rotation of the vehicle seat around the fixed support point 4 occurs, through which the person P is tilted into the status marked by P2. Through the targeted, controlled tilting of the vehicle seat 1 and the person P located thereon into the status P2, the person P undergoes a force input at a physiologically more favorable angle acting on the person P, so that the danger of injury to the person P is significantly reduced. The rotation shown in the figure also allows an increase of the distance to the door area 6, through which the crumple zone area is enlarged.

The exemplary embodiment described above allows a targeted rotation of the driver seat around the x axis shown in the figure, through which a danger of injury in side impact situations may be significantly reduced. Of course, the exemplary embodiment shown in the figure may be expanded by using multiple actuators so that a targeted rotation of the vehicle seat 1 around the y axis is also possible, in order to perform rotational movements of the vehicle seat 1 which have an advantageous effect on the physiological carrying capacity of the person P in case of a frontal impact. Rotations around the z axis are also conceivable through appropriate positioning of actuators.

### LIST OF REFERENCE NUMBERS

1 vehicle seat

2 fixing mechanism

3 vehicle floor

4 spherical element/fixed bearing

5 actuator

6 vehicle door

7 roof area

8 threshold area

1. A device for protecting passengers in a motor vehicle, by reducing a force input, which is caused during a collision of the vehicle, physiologically acting on a passengers seated on a vehicle seat, using a vehicle seat positioned movably in relation to the vehicle, which may be set in motion in relation to the vehicle from a rest position by at least one activatable actuator, an analysis and control unit, which activates the actuator for targeted vehicle seat movement as a function of sensor signals, which originate from sensors attached to the vehicle and are of predefinable reference values, the at least one activatable actuator having an intelligent structure, which undergoes a shape change initiating the vehicle seat movement through activation on a basis of at least one conversion material wherein:
mobility of the vehicle seat is describable by up to three spatial axes comprising an x axis oriented in a vehicle longitudinal direction, a y axis oriented perpendicularly to the x axis, which is also oriented perpendicularly to a vertical axis passing through the vehicle seat, and a z axis,
at least one actuator is positioned so that the entire vehicle seat is pivotable around the x axis, and
the entire vehicle seat is pivotable around the y axis.

2. The device according to claim 1, wherein:
the conversion material comprises at least one of piezo ceramic, piezo polymer, electrostrictive ceramic, electrorheological fluid, polymer gel, magnetorheological fluid, magnetoviscous alloy, shape memory alloy or a shape memory polymer.

3. The device according to claim 1, wherein:
at least one actuator is provided in such way that the vehicle seat is pivotable around the z axis.

4. The device according to claim 1, wherein:
at least three, actuators are attached below the vehicle seat between the vehicle and the vehicle seat, which are activatable in case of a collision so that the vehicle seat is pivotable around the x axis and/or around the y axis so that a physiologically more favorable energy input acts on a passengers in the seat before and during the collision than without vehicle seat adjustment.

5. The device according to claim 1 wherein:
the at least one actuator moves the vehicle seat within a plane which is spanned by the x and y axes, and
the vehicle seat is displaceable along a trajectory running in the plane, which is directed in the direction of the energy input.

6. The device according to claim 1, wherein:
the vehicle seat is attached to the vehicle via a fixing mechanism, which may be loosened before and during the collision, and the vehicle seat movement is determined by the at least one actuator.

7. The device according to claim 6, wherein:
the fixing mechanism is at least partially manufactured from a conversion material, which assumes an open status through activation.

8. The device according to claims 3, wherein:
the vehicle seat rests centrally on a lockable pivot bearing, which is unlockable in case of collision,
and at least one actuator is provided, which pivots the vehicle seat clockwise or counterclockwise by a predefinable rotational angle around the z axis in case of a collision.

9. The device according to claim 1, wherein:
the structure operates as a self-regulating structure based on adaptronics.

10. The device according to claim 1, wherein:
the structure operates as a self-regulating structure based on mechatronics.

11. The device according to claim 2, wherein:
at least one actuator is provided in such way that the vehicle seat is pivotable around the z axis.

12. The device according to claim 2, wherein:
at least three, actuators are attached below the vehicle seat between the vehicle and the vehicle seat, which are activatable in case of a collision so that the vehicle seat is pivotable around the x axis and/or around the y axis so that a physiologically more favorable energy input acts on a passenger in the seat before and during the collision than without vehicle seat adjustment.

13. The device according to claim 2, wherein:
the at least one actuator moves the vehicle seat within a plane which is spanned by the x and y axes, and
the vehicle seat is displaceable along a trajectory running in the plane, which is directed in the direction of the energy input.

14. The device according to claim 2, wherein:
the vehicle seat is attached to the vehicle via a fixing mechanism, which may be loosened before and during the collision, and the vehicle seat movement is determined by the at least one actuator.

15. The device according to claim 2, wherein:
the fixing mechanism is at least partially manufactured from a conversion material, which assumes an open status through activation.

16. The device according to claim 2, wherein:
the vehicle seat rests centrally on a lockable pivot bearing, which is unlockable in case of collision,
and at least one actuator is provided, which pivots the vehicle seat clockwise or counterclockwise by a predefinable rotational angle around the z axis in case of a collision.

17. The device according to claim 2, wherein:
the structure operates as a self-regulating structure based on adaptronics.

18. The device according to claim 2, wherein:
the structure operates as a self-regulating structure based on mechatronics.
